(19) United States
(12) Patent Application Publication
(10) Pub. No.: US 2015/0210056 A1
(43) Pub. Date: Jul. 30, 2015

(54) METHOD FOR TREATING SUBSTRATES PRIOR TO BONDING

(71) Applicant: SIKA TECHNOLOGY AG, Baar (CH)

(72) Inventors: Bernhard BOSSHARD, Remetschwil (CH); Wolf-Rudiger HUCK, Gockhausen (CH)

(73) Assignee: SIKA TECHNOLOGY AG, Baar (CH)

(21) Appl. No.: 14/680,621

(22) Filed: Apr. 7, 2015

Related U.S. Application Data
(63) Continuation of application No. PCT/EP2013/070479, filed on Oct. 1, 2013.

(30) Foreign Application Priority Data
Oct. 8, 2012 (EP) 12187574.4
Aug. 7, 2013 (CH) 01361/13

(51) Int. Cl. B32B 38/16; C11D 7/32; B32B 37/18; B32B 37/12; B05D 3/10; B05D 5/00

(52) U.S. Cl. CPC B32B 38/162; B05D 3/10; B05D 5/00; B32B 37/18; B32B 37/12; C11D 7/3281; B32B 2038/0052

(57) ABSTRACT

The present disclosure relates to a method for treating substrates, including cleaning the substrate surface with a melamine foam and of activating of the cleaned substrate surface. The present disclosure further relates to the use of a melamine foam for removing silicone soiling from substrates. The method has proven advantageous in particular for cleaning laminated safety glass panes because it is possible to easily and quickly remove silicone residue adhering to such panes. A suitable selection of the activating agent additionally makes it possible to carry out the cleaning, detecting and activating within a single processing operation, thus significantly simplifying and accelerating the cleaning methods for surfaces used in the related art.

### RELATED APPLICATION(S)

This application claims priority as a continuation application under 35 U.S.C. §120 to PCT/EP2013/070479, which was filed as an International Application on Oct. 1, 2013 designating the U.S., and which claims priority to European Application No. 12187574.4 filed in Europe on Oct. 8, 2012 and Swiss Application No. 01361/13 filed in Switzerland on Aug. 7, 2013. The entire contents of these applications are hereby incorporated by reference in their entireties.

### FIELD

The disclosure relates to a method for treating substrates, including the steps of cleaning the substrate surface with a melamine foam and activating of the cleaned substrate surface, and to the use of a melamine foam to remove soiling, for example, silicone soiling, from substrates, such as glass or glass ceramics. With the help of the melamine foam, soiling can be removed particularly easily from corresponding surfaces, without requiring the use of abrasive additives for this purpose, which are present in known cleaning agents and removed prior to later adhesive bonding.

### BACKGROUND INFORMATION

In the production of laminated glass, two or more glass panes having interposed plastic films, for example, made of polyvinyl butyral, are joined. The two glass panes can be heated, together with the film, under a vacuum, to temperatures of approximately 120° C. and more. The vacuum can ensure that no air bubbles form in the composite. To generate the vacuum between the two glass panes, a silicone seal or lip can be applied around the edges of the glass, which is removed after the laminated glass has been produced. Because the joining of the film to the two glass layers can be carried out at an elevated temperature, the silicone seal can partially join to the glass pane. After the silicone seal has been removed, soiling can remain on the glass panel. This soiling can cause the adhesive strength of adhesives on the substrate to be reduced and should be removed with the aid of cleaning agents before the composite material can be bonded to rubber seals, for example, with adhesives.

Such contaminants can be removed with known abrasive cleaning agents or scouring agents in industrial applications. This, however, has the disadvantage that the particles (made of corundum or Aerosil, for example), present in such cleaning agents can partially remain on the substrate after cleaning. So as not to impair later adhesive bonding, the remaining solid particles can be removed from the surface of the substrate after silicone contaminants have been removed. Another problem with the use of scouring agents can be that the substrate surface can be scratched by unsuitable cleaning agents.

Prior to joining multiple glass panels by way of plastic films, initially a glass ceramic layer can be applied to the glass panels, for example by, way of screen printing. This layer can be baked into the glass pane in a further step. Because the glass ceramic layer can be generally applied to the edge of the glass panel, silicone contaminants can also be found on the surface of the glass ceramic after joining multiple glass panels by way of plastic films.

An additional step can be performed with the known cleaning methods to determine whether silicone or other contaminants were removed substantially completely from the surface of a substrate that is to be treated further. This can be referred to as “detecting” or “detection.” This can be determined based on the surface stress of the substrate. Silicone oil or silicone resin-contaminated surfaces can have surface stresses in the range of 20 to 30 mN/m, while clean glass surfaces have surface stresses in the range of 40 mN/m or more. Such surface stress can ensure sufficient wetting of the surface with an adhesive to be applied. In a known method for cleaning, the soiling must therefore initially be removed from the surface with the aid of the described cleaning agents, subsequently the surface can be cleaned to remove remaining particles, and then the surface stress of the substrate can be determined with the aid of test inks. It is obvious that this can be a complex process that can be relatively prone to errors and has many different steps, in particular because all three steps must be repeated if the cleaning step was not sufficient.

U.S. Publication No. 2009/025851 A1 proposes a method for cleaning, in particular, glass surfaces contaminated with silicone compounds, in which water mixed with silica or silicates can be used as the cleaning agent. This disclosure proposes, in particular Aerosols as silicate additives, which are applied as an aqueous suspension to the glass surface using a cellulose cloth. Cleaning can then be carried out by rubbing the cloth soaked with liquid over the surface.

Melamine-formaldehyde foams or sponges were already described in the related art for use in industrial applications, such as for heat or sound insulation and for fire protection purposes. Melamine foams are also used in the automotive industry, for example to insulate engine compartments and driver cabins of cars or trucks.

It can be a relatively new development to use such melamine foams also in the field of hard surface cleaning. For example, cleaning sponges made from cut or molded pieces of melamine foam were described to remove soiling and/or stains from hard surfaces, such as tiles, walls or floors. WO 2008/090498, for example, describes the cleaning of carpeting with such materials. For example, such melamine foam sponges are presently marketed under the trade name “Mister Clean Magic Eraser®”, “Meister Propper Express Schmutzradierer®” or “Scotch-Brite Fleckenradierer.” U.S. Publication No. 2007/161533 A1 proposes melamine foams soaked with surfactants, bleaching agents, limescale reducing agents, biocides, solvents and mixtures thereof for cleaning hard surfaces. Surfaces mentioned include ceramics such as tiles and floors, but also sanitary fittings such as sinks, and painted surfaces such as those on household appliances. DE 10 2005 003 314 A1 proposes melamine foams for cleaning glass surfaces smudged with cement, among other things. Highly concentrated acids, for example 96% sulfuric acid, were used for cleaning. According to the information found in DE 2005 003 314 A1, the advantage of using melamine foams can be that melamine foams, in contrast to viscose, do not degrade upon contact with such highly concentrated acids and thus make cleaning with such acids possible in the first place.

So as to stabilize the melamine foam and prevent early disintegration of the same, sponges that combine melamine foam and a stabilizing material, such as a stiff polyurethane, are proposed and marketed (for example sold under the trade name Scotch Brite Easy Erasing Pad® by 3M Corp.).

While melamine foams have been used successfully to clean hard surfaces, certain surfaces, notably glass, pose particular challenges in cleaning. Specifically, it must be ensured that the surface is not scratched when removing contaminants from these substrates.

### SUMMARY

A method is disclosed for treating substrates, comprising: i) cleaning a substrate surface with a melamine foam; and ii) activating the cleaned substrate surface.

### DETAILED DESCRIPTION

Against this background, exemplary embodiments of the present disclosure provide a simplified method for cleaning substrates, in particular glass or glass ceramics, in which no soiling remains on the surface after the removal of contaminants and cleaning of this soiling can be dispensed with. Exemplary embodiments of the present disclosure provide a method within the scope of which can be possible, within the lowest number of steps possible, to clean a substrate and determine whether this substrate, after cleaning, has a surface stress that can be suitable for further processing.

An exemplary embodiment of the present disclosure relates to a method for treating substrates, including: i) cleaning the substrate surface with a melamine foam; and ii) activating the cleaned substrate surface.

“Cleaning” in the above-described method can include the removal of contaminants present on the surface of the substrate, which is to say materials that are not an integral part of the actual substrate.

“Activating” in the context of the present disclosure can be understood to mean that the surface stress of the substrate can be adjusted to a value of ≧35 mN/m. The terms activating and priming are used as synonyms in the context of the present disclosure. A surface stress in this range can ensure sufficient wetting of the substrate surface with a coating to be applied, such as a primer and/or adhesive, in later processing steps.

In accordance with an exemplary embodiment of the disclosure the activating can include a chemical modification of the surface that goes beyond cleaning. Such a modification can include the removal of a passive layer (such as an oxide layer), for example, which in the case of a glass substrate is possible by partial etching of the surface using concentrated acid. However, the chemical modification can also be carried out by applying a substance, such as an adhesive promoter, which subsequently interacts with the substrate surface and can then no longer be readily removed from the surface. One example of such a chemical modification of a glass surface can be the treatment with silanes, in which the silanes bind to the glass surface by the formation of Si—O bonds. Another example can be the treatment with titanium alcoholates, in which the titanium binds to the glass surface, releasing alcohols. Within an exemplary embodiment of the present disclosure, activating can be a substance, in particular an adhesive promoter that binds to the substrate surface applied to the surface of the substrate. It can likewise be if the activating agent can be free from protonic acids.

In this context it should be noted that activating of the surface can be possible when a contaminant located thereon was removed, because in particular chemical modification of the surface of the substrate is done after prior removal of the contaminant.

The cleaning within an exemplary embodiment of the present disclosure can take place by rubbing the melamine foam over the substrate surface.

In the present disclosure, “melamine” or “melamine foam” can refer to melamine-formaldehyde foam.

“Thickness” denotes the length (e.g., in mm) of the side having the smallest dimension compared to the other sides of the melamine foam layer (the height of the melamine foam layer). If the melamine foam can be based on a rectangular shape and the melamine foam layer runs parallel to the sides of the shape having the largest surface area (dimensions in the x and y axes), the thickness can denote the dimension in the direction of the y-axis. In the event that the melamine foam can be based on an irregular shape and/or the dimension of the thickness of the melamine foam layer varies (which is to say that the layer can be thicker in some parts of the device than in others), it can be sufficient that the thickness of the melamine foam layer extends at least once over the thickness required herein.

The above-described melamine foam can be produced by mixing the primary starting materials melamine and formaldehyde, or a precursor thereof, with a blowing agent, a catalyst and an emulsifier, injecting the resulting mixture in a mold, and generating heat in the reaction mixture using a suitable means, such as for exemplary heating or irradiating with electromagnetic waves, so as to evoke foaming and curing. The molar ratio of melamine to formaldehyde (which is to say melamine:formaldehyde) for producing a precursor can be, for example, 1:1.5 to 1:4, and particularly 1:2 to 1:3.5, with respect to melamine:formaldehyde. Moreover, the number average molecular weight of the precursor can be, for example, 200 to 1000, determined with the aid of GPC, and particularly 200 to 400. Formalin, which can be an aqueous formaldehyde solution, can be used, for example, as the formaldehyde component.

The following different monomers can be used as monomers for producing the precursor in an amount of, for example, 50 parts by weight (hereinafter abbreviated as “parts”) or less, in particular 20 parts by weight or less, per 100 parts by weight of the sum of melamine and formaldehyde, in addition to melamine and formaldehyde. C1-5 alkyl-substituted melamines, such as methylol melamine, methyl methylol melamine and methyl butylol melamine, urea, urethane, carbonic acid amides, dicyandiamide, guanidine, sulfuryl amides, sulfonic acid amides, aliphatic amines, phenols and the derivatives thereof can be used as other monomers that correspond to melamine. Acetaldehyde, trimethylolacetaldehyde, acrolein, benzaldehyde, furfurol, glyoxal, phthalaldehyde, terephthalaldehyde and the like can be used as aldehydes.

The blowing agents used can be pentane, trichlorofluoromethane, trichlorofluoroethane and the like. However, the use of so-called Fleons®, such as trichlorofluoromethane, can be restricted because of environmental problems and is therefore not preferred. On the other hand, pentane can be preferred in that it easily provides a foam, when used even in a small amount. However, due to the high flammability of pentane, it is advisable to exercise caution when handling it. Furthermore formic acid can commonly be used as the catalyst, and anionic surfactants such as sodium sulfonate can be used as the emulsifier.

The amount of electromagnetic waves to be irradiated for accelerating the curing reaction of the reaction mixtures can be adjusted to, for example 500 to 1000 kW, and particularly to 600 to 800 kW, in electric power consumption based on 1 kg of an aqueous formaldehyde solution that can be added to the mold. If this power is not sufficient, it results in insufficient foaming, which results in the production of a cured product having high density. On the other hand, if the power consumption can be excessive, the pressure can be very high during foaming, which can result in emptying of the mold and even explosion. A power consumption outside this range is therefore not preferred.

The melamine of exemplary embodiments of the present disclosure can be present as a foam. The surface of the foam can include cells, which, for example, can have a diameter in the range of approximately 1 μm to approximately 20 μm, and more particularly in the range of approximately 5 μm to approximately 10 μm.

Melamine foams that can be used within exemplary embodiments of the present disclosure can have a density of, for example, ≦15 g/I.

Suitable melamine-formaldehyde resin foam raw materials are commercially available from BASF under the trade name Basotect® V3012, Basotect® (MF), Basotect® UF, Basotect® G+, Basotect® G, Basotect® TG, Basotect® UL or Basotect® W. Further suitable melamine-formaldehyde resin foams are commercially available as “Mister Clean Magic Eraser®”, “Meister Propper Express Schmutzradierer®” or “Scotch-Brite Fleckenradierer.”

The activating of the cleaned substrate surface can be carried out with an activating agent that can be suitable for adjusting a surface stress of, for example, ≧35 mN/m. The activating can be carried for a time period until the substrate surface has a surface stress of, for example, ≧35 mN/m, in particular of ≧37 mN/m, still more preferably of ≧39 mN/m, and most preferably of ≧40 mN/m. The activating agent preferably is not and contains no protonic acid.

Activating agents containing at least one adhesive promoter, which can be selected from the group consisting of organotitanates, aminosilanes, mercaptosilanes, hydroxysilanes and mixtures thereof, have proven to be particularly expedient in this connection. Organotitanates usable within exemplary embodiments of the present disclosure are in particular alkoxy titanates, such as titanium tetrabutanolate, or sulfoxy titanates, such as tris(dodecylbenzenesulfonato-O)-(propan-2-olato)titanium.

The term “silane” can denote organoalkoxysilanes in the present document, in which, on the one hand, two or three alkoxy groups are bound directly, via an Si—O bond, to the silicon atom and which, on the other hand, have one or two organic groups representing a functional group, or carrying such a group, bound directly, via an Si—C bond, to the silicon atom. Silanes have the property of hydrolyzing upon contact with moisture. This results in the formation of organosilanols and, through subsequent condensation reactions, of organosiloxanes.

The activating agent can be advantageously free from polyisocyanates. It is further preferred for 90 to 99%, for example, by weight of the activating agent to be composed of chemically inert solvents. Such solvents can include hydrocarbons or water. The remainder of the activating agent can be formed by one or more adhesive promoters, which are can be present in the activating agent at, for example, 1 to 10% by weight, and preferably at 3 to 8% by weight.

Activating agents suitable for exemplary embodiments of the present disclosure can contain one or more aminosilanes having no additional mercaptosilane and are described in EP 1 760 128 A1, for example. Their disclosure is hereby incorporated by reference.

Further activating agents can contain a mixture of at least one aminosilane, in particular an aminosilane containing a tertiary amino group, and at least one mercaptosilane. Such activating agents are described in EP 1 923 361 A1, for example.

In an exemplary embodiment, the above-described activating agent is essentially based on water as the solvent. In an exemplary embodiment of the disclosure the agent for activating the cleaned substrate surface contains bis(trimethoxysilylpropyl)amine and mercaptopropyltrimethoxysilane as constituents. Such agents are described in EP 1 894 966 A1, for example, the disclosure of which is hereby incorporated by reference.

In an exemplary embodiment of the disclosure, the above aminosilanes and optionally mercaptosilanes can be dissolved in an organic solvent, and more particularly in a hydrocarbon or mixtures of hydrocarbons. Suitable activating agents are available from Sika Deutschland GmbH, for example, under the trade name Sika® Aktivator or Sika® Aktivator PRO. However, the disadvantage of nonpolar organic solvents, in particular hydrocarbons, is that the testing of the surface stress is generally conducted with a polar solvent such as water. The nonpolar organic solvent can be removed from the substrate surface before testing the surface stress because otherwise it can distort the measurement of the surface stress. For this reason, nonpolar solvent-based activating agents are less preferred.

Suitable organotitanate-containing activating agents are available from Sika Deutschland GmbH, for example, under the trade name Sika® Aktivator-205.

Further suitable activating agents contain hydroxysilanes. Preferred hydroxysilanes are described in EP 1 502 927 A1 as compounds A1, for example.

In certain cases it can be expedient to use a cleaning agent, which can be based on water as the solvent, in addition to the activating agent. Such cleaning agents can additionally contain an organic solvent as the active component, such as in particular isopropanol, and a mixture of multiple surfactants. A suitable cleaning agent is available from Sika Deutschland GmbH, for example, by the designation Sika® CleanGlass.

The present disclosure is not subject to any significant restrictions with respect to the substrates should be treated. However, the hardness of the substrate should be sufficient so that no major amounts of the material are taken off the substrate surface during the cleaning process with the melamine foam. Soft materials, such as thermoplastics, are therefore less suited as substrates for exemplary embodiments of the present disclosure. Suitable materials are inorganic substrates, for example, such as metal substrates, glass or glass ceramic substrates. A further group of substrates that can be treated within the scope of the disclosure are painted substrates, which can be based on the above-described materials. In exemplary embodiments of the present disclosure the substrate can be glass or a glass ceramic.

In exemplary embodiments of the present disclosure, it was surprisingly found that the steps of cleaning and of activating the substrate surface can be combined with the help of the described melamine foam, wherein both steps can be carried out simultaneously. In exemplary embodiments of the present disclosure, the melamine foam can be soaked or wetted with one of the above-described activating agents, and the substrate surface is cleaned with the soaked or wetted melamine foam. Thus, in exemplary embodiments of the present disclosure, the steps of cleaning with the melamine foam and of activating are carried out substantially at the same time, which is to say in one operation. However, it is also possible to apply the activating agent directly to the substrate surface, and to then carry out the cleaning with the untreated melamine foam. Combinations of these cleaning measures are also possible, of course.

In exemplary embodiments of the present disclosure, it was surprisingly found that it is possible, with the help of a suitable activating agent, to determine directly whether the desired surface stress was achieved. The activating agent then can assume the additional function of a test ink, which is used to determine the surface stress of the substrate by way of the wetting behavior thereof with the activating agent. It is thus possible to determine even during cleaning whether the treated surface has a surface stress that is suitable for further treatment, and more particularly for later adhesive bonding. It is therefore preferred for the activating agent to have a surface tension, for example, of 35 mN/m, in particular of 37 mN/m, still more preferably of 39 mN/m, and most preferably of 40 mN/m. Because test inks are generally based on water as the solvent, the use of aqueous activating agents is preferred within exemplary embodiments of the present disclosure.

The above-described method can advantageously be refined by adhesively bonding the cleaned and activated substrate, which hereafter is to be referred to as S1, to a suitable further substrate S2. For this purpose, the method according to exemplary embodiments of the disclosure can include an additional step of adhesively bonding the activated cleaned substrate surface.

In principle, any suitable adhesive can be used for the adhesive bonding. However, it is preferred within exemplary embodiments of the present disclosure if a polyurethane adhesive, and more particularly a single-component polyurethane adhesive, is used for adhesive bonding.

Suitable adhesives are thus generally compositions that contain polyurethane prepolymers. Substance names beginning with “poly” such as polyisocyanate, polyurethane, polyurea, polyol or polycarbonate, for example, in the present document denote substances that formally contain two or more of the functional groups occurring in their names per molecule.

The term “polymer” in the present document can include, on the one hand, a pool of macromolecules that are chemically defined, but differ in terms of degree of polymerization, molecular weight and chain length, the pool having been produced by a polyreaction (polymerization, polyaddition, polycondensation). On the other hand, the term can also include derivatives of such a pool of macromolecules from polyreactions, which is to say compounds that were obtained by reactions, for example additions or substitutions, of functional groups on predetermined macromolecules and which can or cannot be chemically defined. The term furthermore can include what are known as prepolymers, which is to say reactive oligomers, the functional groups of which are involved in the creation of macromolecules.

The term “polyurethane polymer” can include all polymers that are produced according to the diisocyanate polyaddition process. This also includes such polymers which are virtually or entirely free from urethane groups. Examples of polyurethane polymers are polyester polyurethanes, polyether polyurethanes, polyurethane polyureas, polyureas, polyester polyureas, polyisocyanurates or polycarbodiimides.

The composition of the polyurethane adhesive contains at least one isocyanate group including polyurethane polymer, which can be produced from at least one polyisocyanate and at least one polyol. This reaction can take place by causing the polyol and the polyisocyanate to react using known methods, for example at temperatures of, for example, 50° C. to 100° C., optionally also using suitable catalysts, wherein the polyisocyanate is metered such that the isocyanate groups thereof are present in a stoichiometric excess in relation to the hydroxyl groups of the polyol. The polyisocyanate is advantageously metered such that an NCO/OH ratio of, for example, 1.5 to 5, and more particularly of 1.8 to 3, is maintained. The NCO/OH ratio here shall be understood to mean the ratio of the number of isocyanate groups used to the number of hydroxyl groups used. After the reaction of all hydroxyl groups of the polyol, a content of free isocyanate groups of, for example, 0.5 to 15% by weight, and particularly preferably of 1.0 to 10% by weight, remains in the polyurethane polymer.

Commercially available aliphatic, cycloaliphatic or aromatic polyisocyanates, and more particularly diisocyanates, can be used as polyisocyanates for the production of a polyurethane polymer. For example, these are diisocyanates, the isocyanate groups of which are bound in each case to an aliphatic, cycloaliphatic or arylaliphatic carbon atom, also referred to as “aliphatic diisocyanates,” such as 1,6-hexamethylene diisocyanate (HDI), 2-methyl-pentamethylene-1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexane-1,3 diisocyanate, cyclohexane-1,4 diisocyanate, 1-isocyanato-3,3,5-trimethyl-5-isocyanatomethyl cyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis-(isocyanatomethyl)-cyclohexane, m- and p-xylylene diisocyanate (m- and p-XDI), m- and p-tetramethyl-1,3-xylylene diisocyanate, m- and p-tetramethyl-1,4-xylylene diisocyanate, bis-(1-isocyanato-1-methylethyl)-naphthalene; as well as diisocyanates having isocyanate groups bound in each case to an aromatic carbon atom, also referred to as “aromatic diisocyanates,” such as 2,4- and 2,6-toluylene diisocyanate (TDI), 4,4′-, 2,4′- and 2,2′-diphenylmethane diisocyanate (MDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI); oligomers and polymers of the aforementioned isocyanates, as well as arbitrary mixtures of the aforementioned isocyanates. Aliphatic diisocyanates, and more particularly HDI and IPDI, are preferred for formulating light-stable compositions. MDI and TDI are preferred among the aromatic diisocyanates.

For example, the following commercially available polyols, or mixtures thereof, can be used as polyols for the production of a polyurethane polymer: polyoxyalkylene polyols, also referred to as polyether polyols or oligoetherols, which are polymerization products of ethylene oxide, 1,2-propylene oxide, 1,2- or 2,3-butylene oxide, tetrahydrofuran or mixtures thereof, optionally polymerized with the aid of a starter molecule having two or more active hydrogen atoms, such as water, ammonia or compounds having multiple OH or NH groups, such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexane dimethanol, bisphenol A, hydrogenated bisphenol A, 1,1,1-trimethylolethane, 1,1,1-trimethylolpropane, glycerin, aniline, shorter-chain polyether polyols, as well as mixtures of the aforementioned compounds. It is possible to use both polyoxyalkylene polyols that have low levels of unsaturation (as measured according to ASTM D-2849-69 and indicated in milliequivalents unsaturation per gram of polyol (mEq/g)), for example produced with the aid of what are known as double metal cyanide complex catalysts (DMC catalysts), and polyoxyalkylene polyols that have higher levels of unsaturation, for example produced with the aid of anionic catalysts such as NaOH, KOH, CsOH or alkali alcoholates;

Polyether polyols grafted with styrene-acrylonitrile or acrylonitrile-methyl methacrylate; polyester polyols, also referred to as oligoesterols, for example produced from dihydric to trihydric alcohols, such as 1,2-ethanediol, diethylene glycol, 1,2-propanediol, dipropylene glycol, 1,4-butanediol, 1,5-pentanediol, 1,6-hexanediol, neopentyl glycol, glycerin, 1,1,1-trimethylolpropane or mixtures of the aforementioned alcohols with organic dicarboxylic acids or the anhydrides or esters thereof, such as succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid, or mixtures of the aforementioned acids, as well as polyester diols made from lactones, such as caprolactone; polycarbonate polyols, such as those obtainable by reacting, for example, the above-mentioned alcohols—used for the synthesis of the polyester polyols—with dialkyl carbonates, diaryl carbonates or phosgene; polyacrylate and polymethacrylate polyols; polyhydrocarbon polyols, also referred to as oligohydrocarbonols, such as polyhydroxy-functional ethylene propylene, ethylene-butylene- or ethylene-propylene-diene copolymers, as they are produced, for example, by Kraton Polymers, or polyhydroxy-functional copolymers of dienes, such as 1,3-butadiene or diene mixtures and vinyl monomers such as styrene, acrylonitrile or isobutylene, or polyhydroxy-functional polybutadiene polyols, for example those produced by the copolymerization of 1,3-butadiene and allyl alcohol and which can also be hydrogenated; polyhydroxy-functional acrylonitrile/polybutadiene copolymers, as they can be produced, for example, from epoxides or amino alcohols and carboxyl-terminated acrylonitrile/polybutadiene copolymers (commercially available from Emerald Performance Materials, LLC., USA by the name of Hycar® CTBN).

Polyoxyalkylene diols or polyoxyalkylene triols, and more particularly polyoxypropylene diols or polyoxypropylene triols, are particularly suitable.

So-called ethylene oxide-terminated (“EO-endcapped”, ethylene oxide-endcapped) polyoxypropylene polyols are likewise particularly suitable. The latter are special polyoxypropylene polyoxyethylene polyols, which can be obtained, for example, by further alkoxylating pure polyoxypropylene polyols, in particular polyoxypropylene diols and triols, after the polypropoxylation reaction with ethylene oxide is completed, as a result of which these have primary hydroxyl groups.

Polytetrahydrofuran diols are likewise particularly suitable.

These described polyols can have an average molecular weight of, for example, 250 to 30,000 g/mol, in particular of 400 to 8,000 g/mol, and an average OH functionality in the range of 1.7 to 3.

In addition to these described polyols, small amounts of low-molecular-weight dihydric or polyhydric alcohols can be used, such as 1,2-ethanediol, 1,3- and 1,4-butanediol, 1,2- and 1,3-propanediol, neopentyl glycol, diethylene glycol, triethylene glycol, the isomeric dipropylene glycols and tripropylene glycols, the isomeric pentanediols, hexanediols, heptanediols, octanediols, nonanediols, decanediols, undecanediols, 1,3- and 1,4-cyclohexane dimethanol, hydrogenated bisphenol A, dimeric fatty alcohols, 1,1,1-trimethylolethane, 1,1,1-trimethylolpropane, glycerin, pentaerythritol, sugar alcohols such as xylitol, sorbitol or mannitol, sugars such as sucrose, other polyalcohols, low-molecular-weight alkoxylation products of the aforementioned dihydric and polyhydric alcohols, as well as mixtures of the aforementioned alcohols in the production of a polyurethane polymer. It is likewise possible to use small amounts of polyols having an average OH functionality of more than 3, such as sugar polyols.

The composition of the polyurethane adhesive moreover can include a filler. The filler can influence both the rheological properties of the uncured composition and the mechanical properties and surface finish of the cured composition. Suitable fillers are inorganic and organic fillers, for example natural, ground or precipitated calcium carbonates, which are optionally coated with fatty acids, in particular stearates, barium sulfate (BaSO₄, also referred to as barite or heavy spar), calcined kaolins, aluminum oxides, aluminum hydroxides, silicic acids, in particular finely dispersed silicic acids from pyrolysis processes, carbon blacks, in particular industrially produced carbon black (hereinafter referred to as “carbon black”), PVC powders or hollow spheres. Preferred fillers are calcium carbonates, calcined kaolins, carbon black, finely dispersed silicic acids and flame retardant fillers such as hydroxides and hydrates, in particular hydroxides or hydrates of aluminum, preferably aluminum hydroxide.

It is certainly possible, and can even be advantageous, to use a mixture of different fillers.

A suitable amount of filler ranges from 10 to 80% by weight, for example, and preferably from 15 to 60% by weight, based on the total composition.

The adhesive composition can furthermore include a solvent, wherein care must be taken that this solvent does not contain any groups that are reactive with isocyanate groups, and more particularly no hydroxyl groups and no other groups containing active hydrogen.

Suitable solvents are in particular can be selected from the group consisting of ketones, esters, ethers, aliphatic and aromatic hydrocarbons, halogenated hydrocarbons and N-alkylated lactams. Suitable ketones are, for example, acetone, methyl ethyl ketone, diisobutyl ketone, acetylacetone, mesityl oxide, cyclohexanone and methylcyclohexanone; suitable esters are acetates, such as ethyl acetate, propyl acetate and butyl acetate, formates, propionates, and malonates such as diethyl malonate; suitable ethers are dialkyl ethers, such as diisopropyl ether, diethyl ether, dibutyl ether, diethylene glycol diethyl ether and ethylene glycol diethyl ether, ketone ethers and ester ethers; suitable aliphatic and aromatic hydrocarbons are toluene, xylene, heptane, octane and crude oil fractions such as naphtha, white spirit, petroleum ether and benzine; halogenated hydrocarbons such as methylene chloride; and N-alkylated lactams such as N-methyl pyrrolidone.

Preferred solvents are xylene, toluene, white spirit and crude oil fractions in the boiling range of, for example, 100° C. to 200° C.

Suitable amounts of solvent typically range from, for example, 0.5 to 20% by weight, and more particularly from 1 to 10% by weight, based on the total composition.

The composition of the polyurethane adhesive advantageously can include at least one plasticizer. Such plasticizers are in particular esters of organic carboxylic acids or the anhydrides thereof, for example phthalates such as dioctyl phthalate, diisononyl phthalate or diisodecyl phthalate, adipates such as dioctyl adipate, azelates and sebacates; organic phosphoric and sulfonic acid esters, polybutenes and polyisobutenes.

Further constituents can be present in the composition of the polyurethane adhesive. Further constituents are in particular auxiliary substances and additives, such as: catalysts, such as are common in polyurethane chemistry, in particular tin and bismuth compounds; fibers, made of polyethylene, for example; pigments, for example titanium dioxide or iron oxides; rheology modifiers, such as thickeners or thixotropic agents, in particular urea compounds, polyamide waxes, bentonites or pyrogenic silicic acids; reactive diluents or cross-linking agents, for example low-molecular-weight oligomers and derivatives of diisocyanates such as MDI, PMDI, TDI, HDI, 1,12-dodecamethylene diisocyanate, cyclohexane-1,3-diisocyanate or cyclohexane-1,4-diisocyanate, IP DI, perhydro-2,4′-diphenylmethane diisocyanate and perhydro-4,4′-diphenylmethane diisocyanate, 1,3- and 1,4-tetramethyl xylylene diisocyanate, in particular isocyanurates, carbodiimides, uretonimines, biurets, allophanates and imino-oxadiazine diones of the described diisocyanates, adducts of diisocyanates with short-chain polyols, adipic acid dihydrazide and other dihydrazides, as well as blocked curing agents in the form of polyaldimines, polyketimines, oxazolidines or polyoxazolidines; desiccants, such as molecular sieves, calcium oxide, highly reactive isocyanates such as p-tosyl isocyanate, orthoformic acid ester, alkoxysilanes such as tetraethoxysilane, organoalkoxysilanes such as vinyltrimethoxysilane, and organoalkoxysilanes having a functional group in alpha position relative to the silicon atom; adhesive promoters, in particular silanes, such as vinylsilanes, (meth)acrylsilanes, isocyanatosilanes, carbamatosilanes, S-(alkylcarbonyl)-mercaptosilanes and aldiminosilanes, oligomeric forms of these silanes, as well as adducts of aminosilanes and mercaptosilanes with polyisocyanates; non-reactive thermoplastic polymers, such as homopolymers or copolymers of unsaturated monomers, in particular of unsaturated monomers, selected from the group consisting of ethylene, propylene, butylene, isobutylene, isoprene, vinyl acetate or higher esters thereof, and (meth)acrylate, wherein ethylene vinyl acetate (EVA) copolymers, atactic poly alpha olefins (APAO), polypropylene (PP) and polyethylene (PE); stabilizers against heat, light and UV radiation; flame retardants; surfactants, such as wetting agents, leveling agents, deaerating agents or defoaming agents; biocides, such as algicides, fungicides or fungal growth-inhibiting substances; and further substances known to be used in polyurethane compositions.

It can be advantageous to select all the described constituents that are optionally present in the composition of the polyurethane adhesive in such a way that the storage stability of the composition is not impaired by the presence of such a constituent, which is to say that the properties of the composition, in particular the application and curing properties, do not change or change only little during storage. This requires that reactions which lead to the chemical curing of the described composition, in particular those of the isocyanate groups, should not take place to a significant degree during storage. It therefore can be particular advantageous that the described constituents do not contain any water, or at most contain traces of water, or do not release the same during storage. It can therefore be useful and advisable to chemically or physically dry certain constituents prior to mixing them into the composition.

The polyurethane adhesive can moreover include tertiary amines and anhydrides as functional components, as is described in EP 2 011 809 A1. Likewise, the polyurethane adhesive can include polyaldimines or dialdimines as functional components, as is described in EP 2 090 601 A1. The polyurethane adhesives described in WO 2002/092714 A1 can also be used in exemplary embodiments of the present disclosure.

For example, an adhesive that is particularly suitable in the context of the present disclosure is Sika Tack® Move^{IT} from Sika Deutschland GmbH.

In one exemplary embodiment of the present disclosure, a substrate S2 is brought in contact with the above-described substrate S1 after the adhesive has been applied, S1 having been cleaned and activated prior to applying the adhesive and optionally additionally primed. Thereafter, the adhesive bond is cured.

The substrate S2 can be selected from the group consisting of glass, ceramic, glass ceramic, concrete, mortar, brick, clay brick, gypsum, natural stone such as granite or marble, wood, metal or metal alloy such as aluminum, steel, non-ferrous metal or galvanized metal, plastic material such as PVC, polycarbonate, PMMA, polyester or epoxy resin, powder coating, dye or paint, in particular automotive top coat.

In an exemplary embodiment of the disclosure substrate S1 a window pane, and substrate S2 can be a metal or a metal alloy, in particular a painted metal or a painted metal alloy, as they are used in the production of means of transportation, in particular water or land vehicles, preferably automobiles, buses, trucks, trains or ships, automobiles.

After activating and prior to subsequent adhesive bonding, it can be useful to additionally prime the activated substrate surface by treating the same with a known primer. The present disclosure is not subject to any significant restrictions with respect to this primer. The primer can contain at least one polyisocyanate as the active component.

Suitable primers are based, for example, on mixtures of a hexamethylene-1,6-diisocyanate homopolymer, tris(p-isocyanatophenyl)thiophosphate and isophorone diisocyanate homopolymer as the active components and are available from Sika Deutschland GmbH as Sika® Primer-206 G+P.

The primers used in exemplary embodiments of the present disclosure can include a filler, such as carbon black, and have a solvent content of approximately 20% by weight.

Exemplary embodiments of the present disclosure relate to the use of a melamine foam for removing soiling from substrates and for activating the substrates. In exemplary embodiments of the disclosure the soiling is present in the form of silicone soiling, and more particularly in the form of silicone oil soiling and/or silicone resin soiling. The substrate from which the soiling is to be removed can be glass or a glass ceramic. The substrate can be a safety glass, for example, a laminated safety glass.

Exemplary embodiments of the present disclosure relate to a method for removing silicone soiling from surfaces including:

i) cleaning the substrate surface with a melamine foam; and
ii) activating the cleaned substrate surface.

The above comments on methods for treating substrates apply analogously to exemplary embodiments of this method. In particular, the activating of the substrate surface can take place by treatment with an activating agent. However, it is also possible to activate the surface, for example, merely by cleaning with the dry melamine foam.

Exemplary embodiments of the present disclosure relate to a melamine foam, which is wetted or soaked with an activating agent having a surface tension of ≧35 mN/m. The above comments on exemplary embodiments of activating agents apply analogously to the activating agent, which is to say it is likewise preferred, among other things, for the activating agent to include, for example, at least one aminosilane and optionally at least one mercaptosilane. It is particularly preferred for the melamine foam, based on the weight thereof without activating agent, to have a content of activator in the range of, for example, 5 to 100% by weight, and more particularly of 20 to 40% by weight. So as to prevent the solvent in the activating agent from drying out or evaporating, it is expedient to store the melamine foam, which has been wetted or soaked with the activating agent, in a solvent-tight packaging. This packaging can be made of a material that a user can cut open or tear open so as to remove the melamine foam.

The present disclosure will be described hereafter based on examples. However, these are not intended to limit the scope of protection of the application in any way.

### Example 1

The tin side of float glass was used as the substrate for adhesion tests for the following examinations. This substrate was soiled with silicone oil and fingerprints and subsequently stored for 7 days at 50° C. The contaminated substrate was then treated either with felt, with “Fleckweg-Radiergummi” from 3M (melamine foam) or with Basotect from BASF (melamine foam) and with the aqueous activator Sika® HydroPrep® 100 or Sika® HydroPrep® 110. For this purpose, the foam or the felt was soaked with the activator, pressed against the substrate and rubbed. Any remaining activator solution was then removed from the substrate with the help of a cellulose pad. Prior to subsequent adhesive bonding, the substrates were stored under different conditions. RT corresponds to storage for 7 days at room temperature and 50% humidity, WL corresponds to additional storage in water for 7 days at 23° C., and CP corresponds to additional cataplasm storage (in addition to RT and WL) at 70° C. and 100° relative humidity for 7 days. Thereafter, the adhesive strength of an adhesive on the substrate was determined by way of the “bead peel test.” To this end, a cut is made just above the adhesive surface at the end. The cut end of the bead is held with round-nosed pliers and pulled off the base surface. This is done by carefully rolling the bead onto the tip of the pliers and placing a cut perpendicularly to the bead pulling direction down to the bare base surface. The bead peel speed is selected so that a cut has to be made approximately every 3 seconds. The test section should be at least 8 cm. The adhesive remaining on the base surface after the bead has been peeled off is evaluated (cohesion failure). The adhesive properties are evaluated by determining the cohesive share of the adhesive surface based on a visual inspection. The adhesive used was Sika Tack Move^{IT}.

The results of these tests are listed in the following Table 1.

TABLE 1

| Activator: | Application: | Contamination: | RT | WL | CP |
|---|---|---|---|---|---|
| SHP-100 | Felt | Fingerprints | 90 | 30 | 100 |
| | ‘Fleck weg’ eraser, 3M | | 90 | 5 | 100 |
| | Melamine foam | | 80 | 90 | 100 |
| | Felt | Silicone oil | 100 | 60 | 70 |
| | ‘Fleck weg’ eraser, 3M | | 98 | 90 | 100 |
| | Melamine foam | | 95 | 80 | 98 |
| SHP-110 | Felt | Fingerprints | 95 | 90 | 98 |
| | ‘Fleck weg’ cleaner, 3M | | 98 | 98 | 100 |
| | Melamine foam | | 98 | 90 | 100 |
| | Felt | Silicone oil | 100 | 5 | 100 |
| | ‘Fleck weg’ eraser, 3M | | 98 | 80 | 100 |
| | Melamine foam | | 98 | 100 | 100 |

This shows that in particular the silicone oil soiling, which is difficult to remove with the felt material, can be thoroughly removed with melamine foams and the activating reagents. This is not possible with corresponding felt materials, in particular in the case of silicone oil soiling and storage in water for 7 days, or in the case of cataplasma storage.

### Example 2

The substrate used was a glass ceramic surface, part of which exhibited silicone contaminants. The substrate is a laminated safety glass, as is normally used for windshields of automobiles.

This substrate was treated with cleaning agents made of felt, a ‘Fleck weg’ eraser from 3M (melamine foam), and a Basotect from BASF (melamine foam). The activating agent used was Sika® HydroPrep® 100 and a mixture of Sika® CleanGlass and Sika® Aktivator PRO. The substrates were subsequently stored under different conditions and subjected to an adhesive peel test as described in Example 1. The results of this analysis are listed in the following Table 2. The conditions RT, WL and CP correspond to the conditions described in Example 1.

TABLE 2

| Activator: | Application: | Contamination: | RT | WL | CP |
|---|---|---|---|---|---|
| SHP-100 | Felt | Silicone edge | 10 | 0 | 30 |
| | ‘Fleck weg’ eraser, 3M | | 100 | 100 | 100 |
| | Melamine foam | | 100 | 100 | 80 |
| Sika ® CleanGlass + | Felt | Silicone edge | 0 | 70 | 20 |
| Sika ® Aktivator PRO | ‘Fleck weg’ eraser, 3M | | 100 | 100 | 100 |
| | Melamine foam | | 100 | 100 | 90 |

This shows that the adhering silicone contaminants in all cases were effectively removed with the help of the activator and the melamine foam cleaning agents. In contrast, the contaminants could not be completely removed with felt and the corresponding activating agent, so that more than 75% cohesion failure was observed in all cleaning experiments.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for treating substrates, comprising:
i) cleaning a substrate surface with a melamine foam; and
ii) activating the cleaned substrate surface.

2. The method according to claim 1, wherein the activating of the cleaned substrate surface comprises:
treating with an adhesive promoter, which interacts with the substrate surface and thereby adheres to the substrate.

3. The method according to claim 1, wherein i) and ii) are carried out simultaneously, the melamine foam being soaked or wetted with an activating agent, and the substrate surface being cleaned with the soaked or wetted melamine foam, or the activating agent being applied directly to the substrate surface and the cleaning then being carried out with the untreated melamine foam.

4. A method according to claim 1, wherein the method comprises:
adhesive bonding of the activated cleaned substrate surface.

5. A method according to claim 1, wherein an agent having a surface tension of ≧35 mN/m is used for activating.

6. A method according to claim 1, wherein an agent having a surface tension of ≧37 mN/m, is used for activating.

7. A method according to claim 1, wherein an agent having a surface tension of ≧39 mN/m, is used for activating.

8. A method according to claim 5, wherein an agent having a surface tension of ≧40 mN/m, is used for activating.

9. The method according to claim 2, wherein the adhesive promoter is selected from the group consisting of organotitanates, aminosilanes, mercaptosilanes, hydroxysilanes and mixtures thereof.

10. The method according to claim 9, wherein the agent is based on water or an organic solvent.

11. The method according to claim 5, wherein the agent is combined with an additional cleaning agent that contains isopropanol.

12. The method according to claim 6, wherein the agent is combined with an additional cleaning agent that contains isopropanol.

13. The method according to claim 7, wherein the agent is combined with an additional cleaning agent that contains isopropanol.

14. The method according to claim 8, wherein the agent is combined with an additional cleaning agent that contains isopropanol.

15. A method according to claim 1, wherein the substrate is an inorganic substrate.

16. A method according to claim 1, wherein the activated substrate surface is treated with a primer containing at least one polyisocyanate.

17. A melamine foam, which is soaked with an activating agent having a surface tension of ≧35 mN/m.

18. The melamine foam according to claim 13, wherein the melamine foam has a content of activating agent in the range of 5 to 100% by weight, based on the weight of the melamine foam without activating agent.

19. The melamine foam according to claim 13, wherein the melamine foam has a content of activating agent in the range of 20 to 40% by weight, based on the weight of the melamine foam without activating agent.
